(19) United States
(12) Patent Application Publication
(10) Pub. No.: US 2025/0389748 A1
(43) Pub. Date: Dec. 25, 2025

(54) METHOD FOR RECORDING SUDDEN UNINTENDED ACCELERATION OF A VEHICLE USING A PEDAL BLACK BOX AND DEVICE FOR PERFORMING THE METHOD

(71) Applicant: THINKWARE CORPORATION, Seongnam-si (KR)

(72) Inventors: Soon Woo PARK, Seongnam-si (KR); Kang Sik KIM, Seongnam-si (KR)

(21) Appl. No.: 18/931,513

(22) Filed: Oct. 30, 2024

(30) Foreign Application Priority Data
Oct. 31, 2023 (KR) 10-2023-0148521
Oct. 31, 2023 (KR) 10-2023-0148580
Nov. 1, 2023 (KR) 10-2023-0149208
Nov. 1, 2023 (KR) 10-2023-0149209
Oct. 30, 2024 (KR) 10-2024-0151313

(51) Int. Cl. G01P 15/00; G07C 5/02; G07C 5/08; G10L 25/51; H04N 5/77

(52) U.S. Cl. CPC G01P 15/003; G07C 5/02; G07C 5/085; G10L 25/51; H04N 5/77

(57) ABSTRACT

Provided is a method for recording sudden unintended acceleration of a vehicle using a pedal black box, in which the box includes a camera unit, a communication unit, a control unit, a storage unit, an input unit, and a sudden unintended acceleration determination unit, the method comprising: acquiring, from the camera unit, filmed video data of a surrounding area of a pedal part of the vehicle; performing, by the control unit, a first mode for storing the video data in at least one of the storage unit or an external storage device disposed independently of the pedal black box; determining, by the sudden unintended acceleration determination unit, whether the vehicle experiences a sudden unintended acceleration event.

### CROSS-REFERENCE TO RELATED APPLICATIONS

This application claims the benefit of Korean Patent Application Nos. 10-2024-0151313, filed Oct. 30, 2024; 10-2023-0149209, filed Nov. 1, 2023; 10-2023-0149208, filed Nov. 1, 2023; 10-2023-0148580, filed Oct. 31, 2023; and 10-2023-0148521, filed Oct. 31, 2023, the disclosure of each of which is incorporated by reference herein in its entirety.

### TECHNICAL FIELD

The present disclosure relates to a method for recording sudden unintended acceleration of a vehicle using a pedal black box and a device for performing the method.

### TECHNOLOGY BACKGROUND OF THE INVENTION

In recent years, many vehicle accidents have been reported involving videos or situations where sudden unintended acceleration is suspected, and drivers have been claiming the sudden unintended acceleration of his/her vehicle. However, there is no clear method to prove whether the suspected sudden unintended acceleration accident actually occurred. Accordingly, only a legal approach regarding who is socially responsible for identifying the cause of an accident is being discussed.

The vehicle may be mounted with a black box for recording the accident situation on video. However, the black box does not record the driver's vehicle manipulation situation. In addition, it is difficult to identify the driver's vehicle manipulation situation through a closed-circuit television (CCTV) or similar means on a road at a time of the accident. Accordingly, when the suspected sudden unintended acceleration accident occurred, a black box video of another vehicle at a scene of the accident may be used to check whether the driver was braking the vehicle involved in the accident or whether tail lights of the vehicle were turned on.

However, it is actually difficult to secure a record to check whether the vehicle was operated as the driver intended.

Therefore, as a solution for the aforementioned social safety issues, a pedal black box, which films and records a brake pedal and an accelerator pedal, is gradually becoming widespread.

The conventional pedal black box may film every moment while the vehicle is driving and store the same in an internal storage device. However, there are often cases where a filmed video of the pedal black box is not properly stored in the internal storage device because the video is not stored due to an error in the internal storage device, or because the internal storage device is separated from the pedal black box due to an accident impact.

If the filmed video of the pedal black box is not properly stored in the internal storage device, it is very difficult to prove that the sudden unintended acceleration is true. If the driver fails to provide an adequate evidence of the sudden unintended acceleration accident of the vehicle, the driver may actually fail to receive compensation for damage caused by the sudden unintended acceleration accident of the vehicle.

### CONTENTS OF THE INVENTION

### Problems to be Solved

An object of the present disclosure is to inhibit a loss of video data by storing the same in both a storage unit and an external storage device when an event of suspected sudden unintended acceleration occurs.

### Means for Solving the Problem

According to embodiments of the present disclosure, provided is a method for recording sudden unintended acceleration of a vehicle using a pedal black box, in which the box includes a camera unit, a communication unit, a control unit, a storage unit, an input unit, and a sudden unintended acceleration determination unit, the method including: acquiring, from the camera unit, filmed video data of a surrounding area of a pedal part of the vehicle; performing, by the control unit, a first mode for storing the video data in at least one of the storage unit or an external storage device disposed independently of the pedal black box; determining, by the sudden unintended acceleration determination unit, whether the vehicle experiences a sudden unintended acceleration event; and ending, by the control unit, the first mode and performing a second mode for storing the video data in both the storage unit and the external storage device if the vehicle is determined to experience the sudden unintended acceleration event in the determining of whether the vehicle experiences the sudden unintended acceleration event.

The determining of whether the vehicle experiences the sudden unintended acceleration event may include receiving, through the communication unit, information on the vehicle from the vehicle.

The information on the vehicle may include a first speed indicating a real-time driving speed of the vehicle, a second speed indicating a real-time global positioning system (GPS) speed of the vehicle, a first acceleration indicating real-time acceleration of the vehicle, a driver foot position state, and real-time acceleration duration of the vehicle.

The determining of whether the vehicle experiences the sudden unintended acceleration event may further include determining whether the vehicle experiences the sudden unintended acceleration event by comparing the first acceleration received through the communication unit with a predetermined second acceleration.

In the determining of whether the vehicle experiences the sudden unintended acceleration event, the vehicle may be determined to experience the sudden unintended acceleration event by the sudden unintended acceleration determination unit if the first acceleration is the second acceleration or more.

The determining of whether the vehicle experiences the sudden unintended acceleration event may further include determining whether the vehicle experiences the sudden unintended acceleration event by comparing a predetermined value with a difference value between the first speed and the second speed, received through the communication unit.

In the determining of whether the vehicle experiences the sudden unintended acceleration event, the vehicle may be determined to experience the sudden unintended acceleration event by the sudden unintended acceleration determination unit if the difference value between the first speed and the second speed is the predetermined value or more.

The determining of whether the vehicle experiences the sudden unintended acceleration event may further include checking information on the driver foot position state in the vehicle that is received through the communication unit, and determining whether the vehicle experiences the sudden unintended acceleration event by comparing a predetermined first threshold time with the real-time acceleration duration of the vehicle that is received through the communication unit.

The driver foot position state in the vehicle may include a first state in which a driver foot is spaced apart from a brake by a predetermined distance, and a second state in which the driver foot presses the brake.

In the determining of whether the vehicle experiences the sudden unintended acceleration event, the vehicle may be determined to experience the sudden unintended acceleration event by the sudden unintended acceleration determination unit if the driver foot position state in the vehicle is the first state and the real-time acceleration duration of the vehicle is the first threshold time or more.

The checking of the information on the driver foot position state in the vehicle and the determining of whether the vehicle experiences the sudden unintended acceleration event may be performed sequentially.

The determining of whether the vehicle experiences the sudden unintended acceleration event may further include comparing the first speed received through the communication unit with a predetermined third speed.

In the comparing of the first speed with the predetermined third speed, whether the vehicle experiences the sudden unintended acceleration may be determined by the sudden unintended acceleration determination unit based on duration of the first speed if the first speed is the third speed or more.

The vehicle may be determined to experience the sudden unintended acceleration event by the sudden unintended acceleration determination unit if the first speed is the third speed or more and the duration of the first speed is a predetermined second threshold time or more.

The determining of whether the vehicle experiences the sudden unintended acceleration event may further include determining whether a predetermined instruction is included in a voice signal generated based on speech of a driver and a passenger that is input through the input unit.

In the determining of whether the predetermined instruction is included in the voice signal, if the instruction is included in the voice signal, whether the vehicle experiences the sudden unintended acceleration may be determined by the sudden unintended acceleration determination unit by comparing a decibel value of the voice signal with a predetermined decibel value.

The vehicle may be determined to experience the sudden unintended acceleration event by the sudden unintended acceleration determination unit if the instruction is included in the voice signal and the decibel value of the voice signal is the predetermined decibel value or more.

According to embodiments of the present disclosure, provided is a pedal black box for recording sudden unintended acceleration of a vehicle, the box including: a camera unit for generating video data by filming a surrounding area of a pedal part of the vehicle; a storage unit including a first storage unit for storing the video data generated by the camera unit; a communication unit capable of communicating with an external device and receiving information on the vehicle from the vehicle; a sudden unintended acceleration determination unit for determining whether the vehicle experiences a sudden unintended acceleration event based on the information on the vehicle that is received through the communication unit; and a control unit for selecting and performing at least one of a first mode and a second mode based on a signal from the sudden unintended acceleration determination unit, wherein in the second mode, the video data is stored in both the storage unit and an external storage device disposed independently of the pedal black box through the communication unit.

According to embodiments of the present disclosure, provided is a program stored on a computer-readable recording-medium including a program code for executing the method for recording sudden unintended acceleration of a vehicle using a pedal black box according to the embodiments of the present disclosure.

According to embodiments of the present disclosure, provided is a computer-readable recording-medium including a program code for executing the method for recording sudden unintended acceleration of a vehicle using a pedal black box according to the embodiments of the present disclosure.

Each feature of the embodiments described above may be implemented in combination in other embodiments as long as the feature does not contradict or exclude other embodiments.

### Effects of the Invention

As set forth above, the method for recording sudden unintended acceleration of a vehicle using a pedal black box according to the embodiments of the present disclosure may inhibit the video data from being lost due to the error occurring in the storage unit by performing the storage mode of the video data in the second mode for storing the video data in both the storage unit and the external storage device when the suspected sudden unintended acceleration event occurs.

As set forth above, the method for recording sudden unintended acceleration of a vehicle using a pedal black box according to the embodiments of the present disclosure may inhibit the video data from being lost even if the internal storage device is separated from the pedal black box due to the accident impact by performing the storage mode of the video data in the second mode for storing the video data in both the storage unit and the external storage device when the suspected sudden unintended acceleration event occurs.

Advantageous effects of the present disclosure are not limited to those mentioned above, and other effects not mentioned here may be obviously understood by those skilled in the art from the description provided above.

### BRIEF DESCRIPTION OF DRAWINGS

FIG. 1 is a view showing a configuration of a vehicle 2000 mounted with a pedal black box according to embodiments of the present disclosure.

FIG. 2 is a view showing a configuration of a control device 2100 of the vehicle shown in FIG. 1.

FIG. 3 is a view showing a configuration of the pedal black box performing a method for recording sudden unintended acceleration of a vehicle according to the embodiments of the present disclosure.

FIG. 4 is a view showing a method for recording sudden unintended acceleration of a vehicle using a pedal black box according to embodiments of the present disclosure.

FIG. 5 is a view showing determining whether a sudden unintended acceleration event shown in FIG. 4 occurs (S50).

FIG. 6 is a view showing performing a second mode (S60) in FIG. 4.

### DETAILED DESCRIPTION

Hereinafter, specific embodiments of the present disclosure are described with reference to the accompanying drawings. A detailed description below is provided to facilitate comprehensive understanding of a method, a device, and/or a system, described in the specification. However, this configuration is only an example and the present disclosure is not limited thereto.

In describing the embodiments of the present disclosure, omitted is a detailed description of a case where it is decided that the detailed description of the known functions or configurations related to the present disclosure may unnecessarily obscure the gist of the present disclosure. In addition, terms described below are defined in consideration of their functions in the present disclosure, and may be construed in different ways based on intentions of users or operators, practices, or the like. Therefore, the terms should be defined on the basis of the contents throughout the specification. Terms used in the detailed description are merely to describe the embodiments of the present disclosure, and should not be construed to be restrictive. A term of a single number may include its plural number unless explicitly indicated otherwise. It should be understood that terms “include”, “have”, or the like, used in the specification specify certain features, numerals, steps, operations, elements, portions, or combinations thereof, and it should not be construed to exclude the presence or possibility of one or more other features, numbers, steps, operations, elements, portions, or combinations thereof other than those described.

In addition, terms “first”, “second”, A, B, (a), (b), and the like, may be used in describing components in an embodiment of the present disclosure. These terms are used only to distinguish any components from other components, and features, sequences, or the like of the corresponding components are not limited to these terms.

Hereinafter, a method for recording sudden unintended acceleration of a vehicle using a pedal black box and a device for performing the method are described with the accompanying drawings.

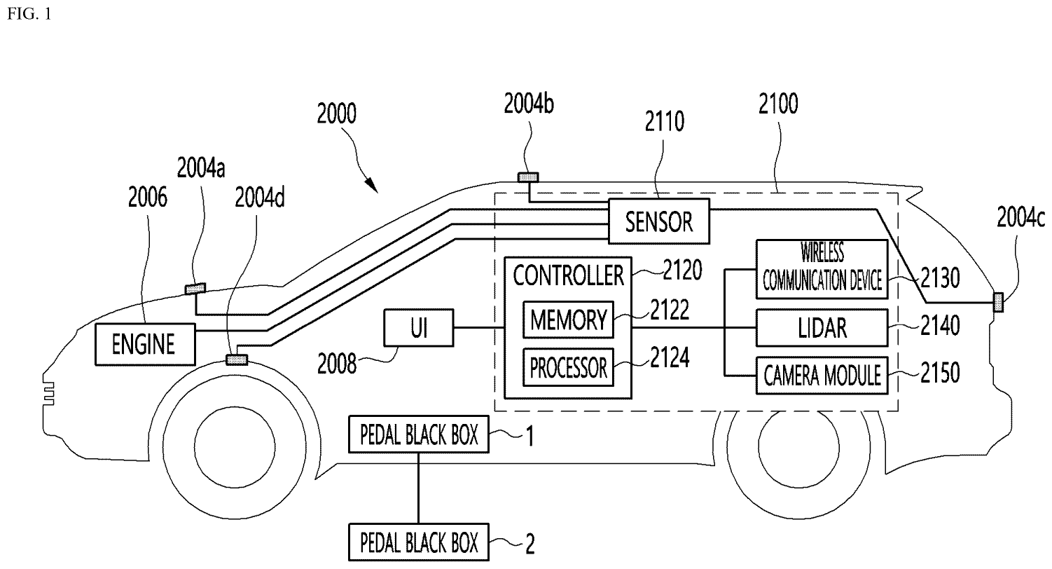

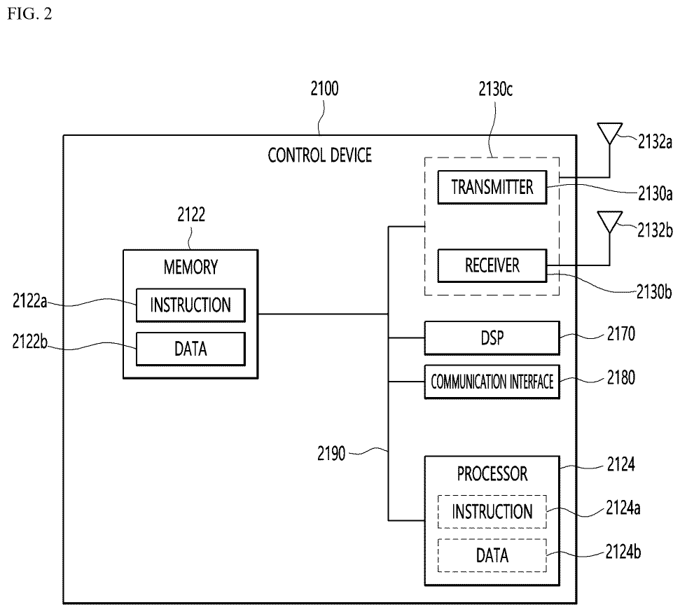

FIG. 1 is a view showing a configuration of a vehicle 2000 mounted with a pedal black box according to embodiments of the present disclosure; and FIG. 2 is a view showing a configuration of a control device 2100 of the vehicle shown in FIG. 1.

Referring to FIGS. 1 and 2, the vehicle 2000 according to the embodiments may be mounted with a pedal black box 1 and a digital room mirror, and the vehicle 2000 may include the control device 2100 for controlling the digital room mirror.

Here, the vehicle 2000 may be an autonomous vehicle. However, the present disclosure is not necessarily limited thereto, and the vehicle 2000 may include all means of transportation defined by Article 2 of the Vehicle Management Act (“vehicle” indicates a tool manufactured to be moved on land by a motor or a tool manufactured to be moved on land by being towed by the tool, excluding what is prescribed by Presidential Decree).

The control device 2100 may control the digital room mirror that displays various information based on a situation to enhance the driving convenience and safety of a driver.

In some embodiments, at least one component of the pedal black box 1 may be integrated into at least one component of the control device 2100.

The control device 2100 may include a controller 2120 including a memory 2122 and a processor 2124, a sensor 2110, a wireless communication device 2130, a light detection and ranging (LiDAR) device 2140, and a camera module 2150.

The controller 2120 may be configured by a manufacturer of the vehicle at a time of manufacture or may be further configured after the manufacture to perform an autonomous driving function. Alternatively, the controller 2120 configured at the time of manufacture may be upgraded to include a configuration for performing a continuous additional function.

The controller 2120 may transmit a control signal to other components within the vehicle, including the sensor 2110, an engine 2006, a user interface (UI) 2008, the wireless communication device 2130, the LIDAR sensor 2140, the camera module 2150, and the pedal black box 1. In addition, although not shown in the drawing, the controller 2120 may also transfer the control signal to an accelerator, a braking system, a steering device, or a navigation device, associated with the driving of the vehicle.

The controller 2120 may control the engine 2006. For example, the controller 2120 may detect a speed limit of a road on which the vehicle 2000 is driven, control the engine 2006 for a driving speed not to exceed the speed limit, or control the engine 2006 to accelerate the driving speed of the vehicle 2000 within a range that does not exceed the speed limit. In addition, when a sensing module 2004a, 2004b, 2004c, or 2004d detects an external environment of the vehicle and transfers the same to the sensor 2110, the controller 2120 may receive information on the external environment and generate a signal to control the engine 2006 or the steering device (not shown), thereby controlling the driving of the vehicle.

The controller 2120 may control the engine 2006 or the braking system to decelerate the driving vehicle when another vehicle or an obstacle exists in front of the vehicle, and control the trajectory, driving path, and steering angle of the vehicle in addition to its speed. Alternatively, the controller 2120 may control the driving of the vehicle by generating a necessary control signal based on recognition information of other external environments such as the driving lane marking and driving signal of the vehicle.

The controller 2120 may also control the driving of the vehicle by communicating with a surrounding vehicle or a central server in addition to generating its own control signal, and transmitting an instruction to control a surrounding device based on the received information.

In addition, it may be difficult to accurately recognize the vehicle or the lane marking when changing the position or angle of view of the camera module 2150. Therefore, the controller 2120 may generate the control signal to control calibration of the camera module 2150 to inhibit this difficulty. Therefore, the controller 2120 may generate the calibration control signal for the camera module 2150, thereby continuously maintaining the normal mounting position, direction, angle of view, or the like of the camera module 2150 even if the mounting position of the camera module 2150 is changed due to vibration or impact caused by a movement of the autonomous vehicle 2000. The controller 2120 may generate the control signal to perform the calibration of the camera module 2150 when the pre-stored initial mounting position, direction, and angle of view information of the camera module 2150 and the initial mounting position, direction, and angle of view information of the camera module 2150 that are measured during the driving of the vehicle 2000 are different from each other by a threshold value or more.

The controller 2120 may include the memory 2122 and the processor 2124. The processor 2124 may execute software stored in the memory 2122 based on the control signal of the controller 2120. In detail, the controller 2120 may store, in the memory 2122, data and instructions for detecting a field of view image from a rear video of the vehicle 2000, and the instructions may be executed by the processor 2124 to implement one or more methods disclosed herein.

Here, the memory 2122 may be stored on a non-volatile storage medium executable by the processor 2124. The memory 2122 may store software and data by using an appropriate internal or external device. The memory 2122 may include the memory device 2122 connected to a random access memory (RAM), a read only memory (ROM), a hard disk, or a dongle.

The memory 2122 may store at least an operating system (OS), a user application, and executable instructions. The memory 2122 may also store application data and array data structures.

The processor 2124 may be a microprocessor or a suitable electronic processor such as the controller, a microcontroller, or a state machine.

The processor 2124 may be implemented as a combination of computing devices, and the computing device may be a digital signal processor, the microprocessor, or a suitable combination thereof.

In addition, the control device 2100 may monitor an internal or external feature of the vehicle 2000 and detect its condition by using at least one sensor 2110.

The sensor 2110 may include at least one sensing module 2004, and the sensing module 2004 may be disposed at a specific position of the vehicle 2000 based on a detection purpose. The sensing module 2004 may be disposed at the bottom, rear, front, top, or side of the vehicle 2000, and also be disposed at the internal part, tire, or the like of the vehicle.

In this way, the sensing module 2004 may detect information related to the driving, such as the engine 2006, the tire, the steering angle, the speed, or a vehicle weight, as internal information of the vehicle. In addition, at least one sensing modules 2004 may include an accelerometer sensor 2110, a gyroscope, an image sensor 2110, a radio detection and ranging (RADAR) device, an ultrasonic sensor, a LiDAR sensor, or the like, and may detect movement information of the vehicle 2000.

The sensing module 2004 may also receive, as external information, specific data on a state of the external environment, such as information on a state of a road where the vehicle 2000 is disposed, information on the surrounding vehicle, and the weather, and detect a parameter of the vehicle based thereon. The detected information may be stored in the memory 2122 for a short or long term based on the purpose.

The sensor 2110 may integrate and collect information from the sensing modules 2004 for collecting the information generated in the interior or exterior of the vehicle 2000.

The control device 2100 may further include the wireless communication device 2130.

The wireless communication device 2130 may implement wireless communication of the vehicle 2000. For example, the wireless communication device 2130 may enable the vehicle 2000 to communicate with a user mobile phone, or another wireless communication device 2130, another vehicle, a central device (traffic control device), a server, or the like. The wireless communication device 2130 may transmit and receive a wireless signal according to a wireless access protocol. The wireless communication protocol may be, wireless-fidelity (Wi-Fi), Bluetooth, long-term evolution (LTE), code division multiple access (CDMA), wideband code division multiple access (WCDMA), or global systems for mobile communications (GSM), and is not limited thereto.

In addition, the vehicle 2000 may also implement inter-vehicle communication through the wireless communication device 2130. That is, the wireless communication device 2130 may communicate with another vehicle or other vehicles on the road based on vehicle-to-vehicle (V2V) communication. The vehicle 2000 may transmit and receive information such as driving warnings and traffic information through the V2V communication, and request information or receive a request from another vehicle. For example, the wireless communication device 2130 may perform the V2V communication by using a dedicated short-range communication (DSRC) device or a cellular-V2V (C-V2V) device. In addition, the wireless communication device 2130 may also implement communication (vehicle to everything (V2X) communication) between the vehicle and another object (for example, an electronic device carried by a pedestrian) in addition to the V2V communication.

In addition, the control device 2100 may include the LIDAR device 2140. The LIDAR device 2140 may detect a surrounding object of the vehicle 2000 during its operation by using data sensed through the LIDAR sensor. The LIDAR device 2140 may transmit detected information to the controller 2120, and the controller 2120 may operate the vehicle 2000 based on the detected information. For example, the controller 2120 may instruct the vehicle to reduce its speed using the engine 2006 when the detection information indicates a slow-moving vehicle ahead. Alternatively, the controller 2120 may instruct the vehicle to reduce its entry speed based on a curvature of a curve into which the vehicle enters.

The control device 2100 may further include the camera module 2150. The controller 2120 may extract object information from an external image captured by the camera module 2150, and cause the controller 2120 to process the information.

In addition, the control device 2100 may further include an imaging device for recognizing the external environment. The control device 2100 may use the RADAR device, a global positioning system (GPS) device, a driving distance measurement device (Odometry), or another computer vision device in addition to the LIDAR device 2140, and the device may be operated selectively or simultaneously as needed to enable more precise detection.

The vehicle 2000 may further include the user interface 2008 for a user input to the control apparatus 2100 described above. The user interface 2008 may allow the user to input information through appropriate interaction. For example, the user interface 2008 may be implemented as a touch screen, a keypad, a manipulation button, or the like. The user interface 2008 may transmit the user input or command to the controller 2120, and the controller 2120 may perform a vehicle control operation in response to the input or command.

In addition, the user interface 2008 may allow the vehicle 2000 to communicate with a device on the exterior of the vehicle 2000 through the wireless communication device 2130. For example, the user interface 2008 may enable the vehicle 2000 to interact with the mobile phone, a tablet, or another computing device.

Furthermore, although the vehicle 2000 is described as including the engine 2006, the vehicle 2000 may also include a different type of propulsion system. For example, the vehicle may be powered by electric energy, hydrogen energy, or a hybrid system combining the two types of energy. Therefore, the controller 2120 may include a propulsion mechanism based on a propulsion system of the vehicle 2000, and provide the control signal based thereon to a component of each propulsion mechanism.

Hereinafter, referring to FIG. 2, the description describes in more detail a detailed configuration of the control device 2100 that controls the digital rear mirror of the vehicle 2000.

The control device 2100 may include the processor 2124. The processor 2124 may be a general-purpose single or multi-chip microprocessor, a dedicated microprocessor, the microcontroller, a programmable gate array, or the like. The processor may be referred to as a central processing unit (CPU). In addition, the processor 2124 may also be used as a combination of the plurality of processors.

The control device 2100 may also include the memory 2122. The memory 2122 may be any electronic component capable of storing electronic information. The memory 2122 may also include a combination of the memories 2122 in addition to a single memory.

According to the various embodiments, the memory 2122 may also store data and instructions 2122a for detecting a field of view image 220 from a rear image 210 of the vehicle 2000. When the processor 2124 executes the instructions 2122a, all or some of the instructions 2122a and data 2122b necessary for performing the instructions may be loaded into instructions 2124a and data 2124b of the processor 2124.

The control device 2100 may include a transmitter 2130a, a receiver 2130b, or a transceiver 2130c to allow transmission and reception of signals. One or more antennas 2132a and 2132b may be electrically connected to the transmitter 2130a, the receiver 2130b, or each transceiver 2130c, and may also include additional antennas.

The control device 2100 may also include a digital signal processor (DSP) 2170. The control apparatus 2100 may enable the vehicle to rapidly process a digital signal by using the DSP 2170.

The control device 2100 may also include a communication interface 2180. The communication interface 2180 may include one or more ports and/or communication modules for connecting other devices to the control device 2100. The communication interface 2180 may enable the user to interact with the control device 2100.

The various components of the control device 2100 may be connected with each other by one or more buses 2190, and the buses 2190 may include a power bus, a control signal bus, a state signal bus, a data bus, and the like. The components may communicate information to each other through the bus 2190 and perform intended functions under control of the processor 2124.

The pedal black box 1 may be fixed to the bottom of a driver seat to film a pedal part of the vehicle that includes the brake pedal and accelerator pedal.

An external storage device 2 may be disposed independently of the pedal black box 1, and receive video data from the pedal black box 1 through a communication unit 40 of the pedal black box 1 described below. The external storage device 2 may store the video data received from the pedal black box 1 in a predetermined storage space.

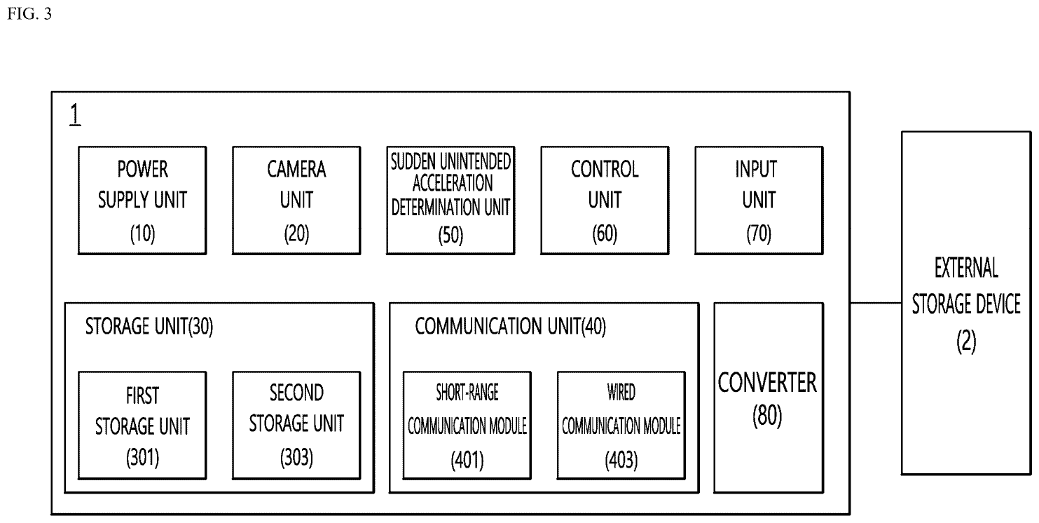

Hereinafter, a detailed configuration of the pedal black box 1 is described in more detail with reference to FIG. 3.

FIG. 3 is a view showing a configuration of the pedal black box performing a method for recording sudden unintended acceleration of a vehicle according to the embodiments of the present disclosure.

Referring to FIG. 3, the pedal black box 1 according to the embodiments may include a power supply unit 10, a camera unit 20, a storage unit 30, the communication unit 40, a sudden unintended acceleration determination unit 50, a control unit 60, an input unit 70, and a converter 80.

The power supply unit 10 may supply power necessary for the operation of the pedal black box 1. The power supply unit 10 may turn on or off the pedal black box 1 as the communication unit 40 described below receives the ignition on signal or ignition off signal of the vehicle 2000.

As the driver manipulates an ignition switch, a start button, or the like for turning an engine key, ignition of the vehicle 2000 may be changed from an off state to an on state. In this case, the vehicle 2000 may transmit the ignition on signal to the communication unit 40 of the pedal black box 1. The control unit 60 may detect that the ignition on signal is received from the vehicle 2000 to the communication unit 40, and transmit, to the power supply unit 10, a signal to control the pedal black box 1 to be turned on.

In addition, as the driver ends the driving and manipulates the ignition switch, the start button, or the like, the ignition of the vehicle 2000 may be changed from the on state to the off state. In this case, the vehicle 2000 may transmit the ignition off signal to the communication unit 40 of the pedal black box 1. Here, the control unit 60 may detect that the ignition off signal is received from the vehicle 2000 to the communication unit 40, and transmit, to the power supply unit 10, a signal to control the pedal black box 1 to be turned off.

The camera unit 20 may generate the video data by including at least one camera to film a surrounding area of the pedal part of the vehicle 2000 that includes the brake pedal and accelerator pedal.

In some embodiments, the camera unit 20 may be installed on the bottom of the driver seat to film all of the pedal part and a driver foot position, a passenger seat, and a passenger window.

The camera unit 20 may be disposed separately from the camera module 2150 of the control device 2100. That is, the camera unit 20 may be installed on the bottom of the driver seat to film the surrounding area of the pedal part, whereas the camera module 2150 may be a type of room mirror camera to film the interior or exterior of the vehicle 2000.

The camera unit 20 may use at least one of a complementary metal-oxide-semiconductor (CMOS) camera, a charge-coupled device (CCD) camera, a wide-angle lens camera, an infrared camera, and a dual lens camera, and may also be a combination of the plurality of cameras.

In some embodiments, the camera unit 20 may include at least one infrared camera to acquire a high-quality video by filming the bottom of the driver seat of the vehicle 2000, which is relatively dark.

The camera unit 20 may have its mounting position, direction, and angle of view, controlled by the control signal to control the calibration of the control unit 60 described below.

The storage unit 30 may be a data storage device built in the pedal black box 1 and storing data required for the operation of the pedal black box 1 and data generated by the operation of the pedal black box 1.

The storage unit 30 may include a first storage unit 301 for storing the video data generated by the camera unit 20, and a second storage unit 303 for storing data required for the various operations of the pedal black box 1.

The first storage unit 301 may be built in the pedal black box 1 and store the video data of the pedal part that is filmed and generated by the camera unit 20.

In some embodiments, the first storage unit 301 may use at least one of an embedded multimedia card (eMMC), NAND, a universal flash storage (UFS), a solid state drive (SSD), a NOR flash memory, a secure digital (SD) card, a compactflash fast (CFast) card, a non-volatile random access memory (NVRAM), and a ferroelectric random access memory (FRAM).

The second storage unit 303 may store software and data by using the appropriate internal or external device. The second storage unit 303 may include the random access memory (RAM), the read only memory (ROM), the hard disk, or the like.

The communication unit 40 may be provided for communication between the pedal black box 1 and the vehicle 2000, the wireless communication device 2130 of the digital room mirror, other devices such as the external storage device 2, or an internal system of the pedal black box 1. The communication unit 40 may include a short-range communication module 401 and a wired communication module 403.

The short-range communication module 401 may transmit and receive the data wirelessly over a short distance, and support interaction between the pedal black box 1 and another device through various short-range wireless communications. The short-range communication module 401 may be any one of Wi-Fi, Bluetooth, long-term evolution (LTE), code division multiple access (CDMA), wideband code division multiple access (WCDMA), global systems for mobile communications (GSM), near field communication (NFC), and Zigbee.

The short-range communication module 401 may be Wi-Fi, and the present disclosure is not necessarily limited thereto.

In some embodiments, the pedal black box 1 may communicate with other devices such as the external storage device 2 or the internal system of the pedal black box 1 through the short-range communication module disposed on an exterior of the pedal black box 1.

The pedal black box 1 may separately store and manage the video data on the external storage device 2 through the short-range communication module 401.

The wired communication module 403 may transmit and receive data through an electrical signal or an optical signal, and use a cable as a medium when transmitting the data. In more detail, the wired communication module 403 may be a universal serial bus (USB) module capable of performing the communication through a USB port.

In some embodiments, the pedal black box 1 in the present disclosure may communicate with another device or the internal system of the pedal black box 1 by using only one of the short-range communication module 401 and the wired communication module 403, or communicate with another device or the internal system of the pedal black box 1 by using both the short-range communication module 401 and the wired communication module 403, as needed.

The sudden unintended acceleration determination unit 50 may determine whether the vehicle 2000 experiences a sudden unintended acceleration event based on at least one information on the vehicle 2000 that is received through the communication unit 40.

The sudden unintended acceleration determination unit 50 may receive the information on the vehicle 2000 from information on the interior or exterior information of the vehicle 2000 or the movement of the vehicle 2000, which is detected by the sensing module 2004.

The information on the vehicle 2000 may include a first speed indicating a real-time driving speed of the vehicle 2000, a second speed indicating a real-time global positioning system (GPS) speed of the vehicle 2000, a first acceleration indicating real-time acceleration of the vehicle 2000, a driver foot position state, and real-time acceleration duration of the vehicle 2000.

In addition to the information on the vehicle 2000, the sudden unintended acceleration determination unit 50 may also determine whether the vehicle 2000 experiences the sudden unintended acceleration event by analyzing a voice signal generated from speech of the driver and the passengers, input through the input unit 70 described below.

In addition, the sudden unintended acceleration determination unit 50 may determine whether the sudden unintended acceleration event occurs based on whether a manual manipulation signal is input to the input unit 70, and also detect a corresponding situation and determine whether the sudden unintended acceleration event occurs when another suspected sudden unintended acceleration event occurs.

The control unit 60 may generate the control signal to control the various operations of the pedal black box 1. The control unit 60 may generate the control signal to perform a corresponding mode by selecting at least one of a first mode or a second mode as the sudden unintended acceleration determination unit 50 determines whether the sudden unintended acceleration event occurs.

The first mode may be a mode for storing the video data filmed by the camera unit 20 in at least one of the storage unit 30 or the external storage device 2 that is disposed independently of the pedal black box 1. In more detail, the first mode may be a mode for storing the video data in the first storage unit 301.

The second mode may be a mode for storing the video data filmed by the camera unit 20 in both the storage unit 30 and the external storage device 2. That is, when the second mode is performed, the video data may be stored in both the first storage unit 301 and the external storage device 2.

In the pedal black box 1 according to the embodiments of the present disclosure, the control unit 60 may perform the control to store the video data in either the first mode or the second mode based on whether the sudden unintended acceleration determination unit 50 determines that the vehicle 2000 experiences the sudden unintended acceleration event.

The control unit 60 may generate the control signal to perform the second mode if the sudden unintended acceleration determination unit 50 determines that the vehicle 2000 currently experiences the sudden unintended acceleration event. As the signal to perform the second mode is generated, the video data filmed by the camera unit 20 may be stored in both the first storage unit 301 and the external storage device 2, thus inhibiting the video data from being lost or damaged even if an error occurs in the first storage unit 301 or the accident impact occurs due to the sudden unintended acceleration.

Meanwhile, the control unit 60 may generate the control signal to transmit, to the driver through at least one of a display unit of the vehicle 2000 (not shown), the user interface 2008, or the voice signal, the data such as whether the vehicle 2000 experiences the sudden unintended acceleration event, whether the first mode or the second mode is in operation, whether a power battery of the pedal black box 1 is charged, and whether the pedal black box 1 is turned on/off.

In addition, the control unit 60 may also control the camera unit 20 to have an angle or the like that is adjusted appropriately to properly film the pedal part video.

The control unit 60 may generate the control signal to control the calibration to thus control the calibration of the camera unit 20 based on the pre-stored initial mounting position, direction, and angle of view information of the camera unit 20 even if the mounting position, direction, and angle of view of the camera unit 20 are changed due to vibration or impact occurring due to the driving of the vehicle 2000.

The input unit 70 may receive a driver input signal including the voice signal and the manual manipulation signal from the driver of the vehicle 2000.

The manual manipulation signal may be a signal generated by the driver manually manipulating a manipulation section (not shown) disposed on the pedal black box 1. The manipulation unit may have the form of an emergency button, and when the driver presses the emergency button, the manual manipulation signal may be input to the input unit 70.

The voice signal may include the voice signals of the driver and the passengers riding in the vehicle 2000 in addition to the driver. The voice signal may be analyzed by the sudden unintended acceleration determination unit 50, and the sudden unintended acceleration determination unit 50 may determine whether the vehicle 2000 experiences the sudden unintended acceleration event based on the voice signal.

The converter 80 may be used to effectively process the data, and convert parallel data to serial data or vice versa.

The converter 80 may process the corresponding data by receiving the data from various sensors and systems of the pedal black box 1 and then converting the same, the various sensors and systems including the power supply unit 10, the camera unit 20, the storage unit 30, the communication unit 40, the sudden unintended acceleration determination unit 50, the control unit 60, the input unit 70, and the like.

In some embodiments, the converter 80 may be a deserializer. Therefore, the converter 80 may process the data by receiving the serialized data collected from the various sensors and systems of the pedal black box 1 and then converting same back into the parallel data.

The various sensors and systems in the pedal black box 1 may record the data in real time, and the data recorded in real time may be serialized to increase transmission efficiency. The converter 80 may assist the pedal black box 1 to process the plurality of signals simultaneously by converting the serialized data back into the parallel data.

The external storage device 2 may be disposed independently of the pedal black box 1.

In some embodiments, the external storage device 2 may be detachably mounted on the pedal black box 1 and use at least one of the secure digital (SD) card, a microSD card, a miniSD card, a compact flash (CF) card, a CFexpress card, an extreme quick data (XQD) card, a universal flash storage (UFS) card, and a USB memory.

However, the present disclosure is not necessarily limited thereto, and the external storage device 2 may exist in the storage space of another device or the server. Accordingly, the video data may also be stored in the storage space of the external storage device 2 including one of a driver mobile phone, a tablet personal computer (PC), a personal computer, and a portable computer, through the short-range communication module 401.

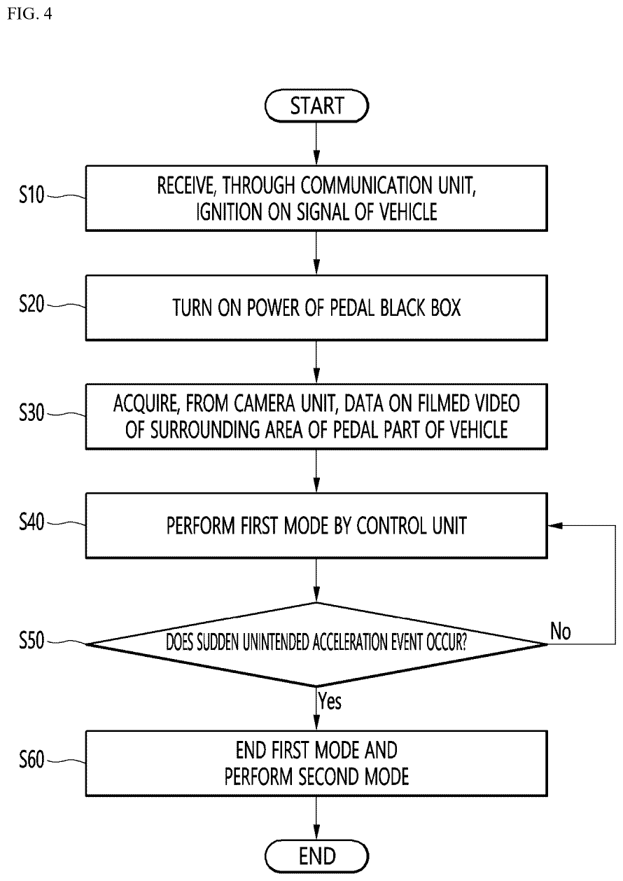

Hereinafter, a method for recording the sudden unintended acceleration of the vehicle 2000 using the pedal black box 1 is described in more detail with reference to FIGS. 4 to 6.

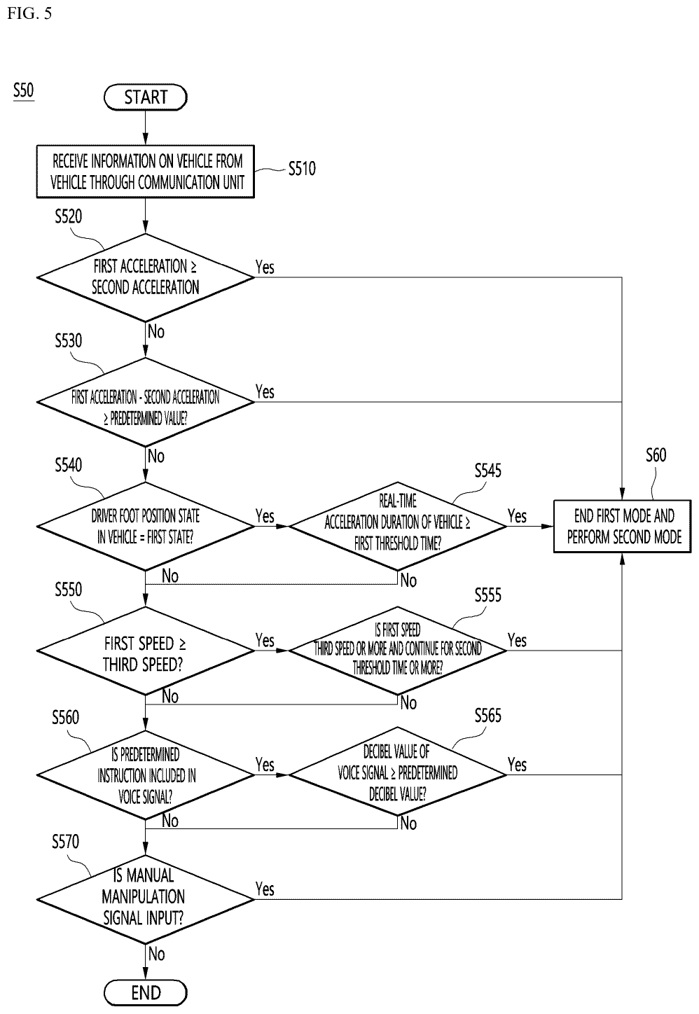

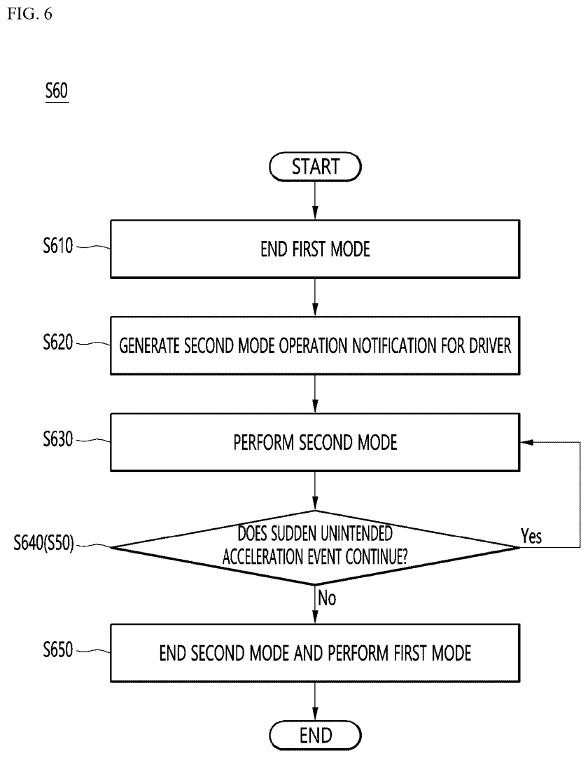

FIG. 4 is a view showing the method for recording sudden unintended acceleration of a vehicle using a pedal black box according to embodiments of the present disclosure; FIG. 5 is a view showing determining whether a sudden unintended acceleration event occurs (S50) as shown in FIG. 4; and FIG. 6 is a view showing performing a second mode (S60) in FIG. 4.

First, the description is provided below with reference to all of FIGS. 1 to 4.

The method for recording the sudden unintended acceleration of the vehicle 2000 using the pedal black box 1 according to the embodiments of the present disclosure may include: receiving, through the communication unit 40, an ignition on signal of the vehicle 2000 (S10); turning on, by the power supply unit 10, power of the pedal black box 1 (S20); acquiring, from the camera unit 20, the data on the filmed video of the surrounding area of the pedal part of the vehicle 2000 (S30); performing, by the control unit 60, the first mode (S40); determining, by the sudden unintended acceleration determination unit 50, whether the vehicle 2000 experiences the sudden unintended acceleration event (S50); and ending the first mode and performing the second mode (S60).

The signal may be received, through the communication unit 40, from the vehicle 2000 based on the ignition state change. The ignition on signal may be received from the vehicle 2000 through the communication unit 40 when the ignition of the vehicle 2000 is changed from the off state to the on state based on the driver manipulation (S10).

When the ignition on signal of the vehicle 2000 is received through the communication unit 40 (S10), the ignition on signal may be detected by the control unit 60 and the signal to control power of the pedal black box 1 to be turned on may be transmitted to the power supply unit 10.

The pedal black box 1 may be controlled by the power supply unit 10 from the off state to the on state based on the control signal of the control unit 60 (S20).

After the step S20, the video data may be acquired by the camera unit 20 by filming the surrounding area of the pedal part of the vehicle 2000 that includes the brake pedal and the accelerator pedal (S30).

The first mode for storing the video data filmed by the camera unit 20 in at least one of the storage unit 30 or the external storage device 2 disposed independently of the pedal black box 1 may be performed by the control unit 60 (S40).

In some embodiments, the first mode may be the mode for storing the video data filmed by the camera unit 20 in the first storage unit 301.

After the step S40, whether the vehicle 2000 experiences the sudden unintended acceleration event may be determined by the sudden unintended acceleration determination unit 50 (S50).

The first mode may be ended and the second mode may be performed, by the control unit 60 (S60), if the vehicle 2000 is determined to currently experience the sudden unintended acceleration event by the sudden unintended acceleration determination unit 50 (Yes in S50).

In some embodiments, the second mode may be the mode for storing the video data filmed by the camera unit 20 in both the first storage unit 301 and the external storage device 2.

Meanwhile, the video data may be continuously controlled by the control unit 60 to be stored in the first mode (S40) if the vehicle 2000 is determined not to currently experience the sudden unintended acceleration event by the sudden unintended acceleration determination unit 50 (No in S50).

In the step S40, whether the sudden unintended acceleration event occurs may be determined by the pedal black box 1 for each predetermined time (S50).

The loss of the video data of the pedal black box 1 may be inhibited by the pedal black box 1 according to the embodiments of the present disclosure by ending the first mode and performing the second mode (S60) for storing the video data filmed by the camera unit 20 in both the storage unit 30 and the external storage device 2 if the vehicle 2000 is determined to currently experience the sudden unintended acceleration event by the sudden unintended acceleration determination unit 50 (Yes in S50).

Prior to the step S60, activating the short-range communication module 401 by the control unit 60 may be performed (not shown). The second mode may be performed by the control signal to activate the short-range communication module 401 generated by the control unit 60 if the vehicle 2000 is determined to currently experience the sudden unintended acceleration event by the sudden unintended acceleration determination unit 50 (Yes in S50).

Hereinafter, the determining of the sudden unintended acceleration event (S50) is described in more detail with reference to all of FIGS. 1 to 5.

The information on the vehicle 2000 that includes the interior or exterior information of the vehicle 2000 or its driving information that is detected by the sensing module 2004 of the vehicle 2000 may be received by the sudden unintended acceleration determination unit 50 through the communication unit 40 (S510).

The information on the vehicle may include the first speed indicating the real-time driving speed of the vehicle 2000, the second speed indicating the real-time global positioning system (GPS) speed of the vehicle 2000, the first acceleration indicating the real-time acceleration of the vehicle 2000, the foot position state of the driver, and the real-time acceleration duration of the vehicle 2000.

Whether the vehicle 2000 experiences the sudden unintended acceleration event may be determined by the sudden unintended acceleration determination unit 50 by comparing the information on the vehicle that is received through the communication unit 40.

After the step S510, whether the vehicle 2000 experiences the sudden unintended acceleration event may be determined by the sudden unintended acceleration determination unit 50 by comparing the first acceleration with a predetermined second acceleration (S520).

Here, the second acceleration may indicate the maximum acceleration of the vehicle 2000. The second acceleration may be set as the maximum acceleration, which is acceleration derived by converting a time taken for the vehicle 2000 to accelerate from a standstill to 100 km/h. The second acceleration may be set to a different value for each vehicle type and stored in the second storage unit 303, or may be set to the same value regardless of the vehicle type.

That is, whether the sudden unintended acceleration event occurs may be determined by the sudden unintended acceleration determination unit 50 by comparing the first acceleration received through the communication unit 40 with the second acceleration predetermined and stored in the second storage unit 303 (S520).

The vehicle 2000 may be determined to experience the sudden unintended acceleration event by the sudden unintended acceleration determination unit 50 if the first acceleration is the second acceleration or more (Yes in S520). The control signal may be generated by the control unit 60 to end the first mode and perform the second mode if the vehicle 2000 is determined to experience the sudden unintended acceleration event by the sudden unintended acceleration determination unit 50 (S60).

Meanwhile, if the first acceleration is less than the second acceleration (No in S520), whether the vehicle 2000 experiences the sudden unintended acceleration event may be determined by the sudden unintended acceleration determination unit 50 by comparing a predetermined value with a difference value between the first speed indicating the real-time driving speed of the vehicle 2000 and the second speed indicating the real-time global positioning system (GPS) speed of the vehicle 2000 (S530).

The global positioning system (GPS) speed may be acquired by transmitting and receiving the signal through a satellite, and calculating the position of the vehicle 2000 based thereon. Therefore, the GPS speed may be different from the real speed of the vehicle 2000 because the satellite requires several seconds to accurately measure the position of the vehicle 2000 to thus have a response speed delayed during rapid acceleration or deceleration of the vehicle, resulting in the difference from the real speed of the vehicle 2000.

Whether the sudden unintended acceleration event occurs may be determined by the sudden unintended acceleration determination unit 50 by receiving the first speed and the second speed through the communication unit 40, acquiring the difference value between the two speeds, and comparing the difference value with the predetermined value.

The difference value may be an absolute value indicating a distance from an origin on a number line regardless of whether the absolute value is negative or positive.

The predetermined value is a value predetermined and stored in the second storage unit 303, and may indicate a tolerance of the difference value between the first speed and the second speed.

In some embodiments, the predetermined value may be between 0.1 and 10 km/h.

In the step S530, if the difference value between the first speed and the second speed is the predetermined value or more (Yes in S530), the vehicle 2000 may be determined to currently experience the sudden unintended acceleration event by the sudden unintended acceleration determination unit 50. The control signal may be generated by the control unit 60 to end the first mode and perform the second mode if the vehicle 2000 is determined to experience the sudden unintended acceleration event by the sudden unintended acceleration determination unit 50 (S60).

Meanwhile, information on the driver foot position state in the vehicle 2000 that is received through the communication unit 40 may be checked by the sudden unintended acceleration determination unit 50 (S540) if the difference value between the first speed and the second speed is less than the predetermined value (No in S530).

The driver foot position state may include a first state in which a driver foot is spaced apart from the brake pedal by a predetermined distance, and a second state in which the driver foot presses the brake pedal. The first state may include a state in which the driver presses the accelerator pedal.

In the step S540, if the driver foot position state in the vehicle 2000 is the first state (Yes in S540), whether the vehicle 2000 experiences the sudden unintended acceleration event may be determined by the sudden unintended acceleration determination unit 50 by comparing a predetermined first threshold time with the real-time acceleration duration of the vehicle 2000 that is received through the communication unit 40 (S545).

The first threshold time is a value predetermined and stored in the second storage unit 303, and may indicate a time that serves as a reference for determining the sudden unintended acceleration event when the acceleration continues for a certain period of time even though the driver does not press the accelerator pedal.

In some embodiments, the first threshold time may be set from 0.5 to 10 minutes.

In the step S545, if the real-time acceleration duration of the vehicle 2000 is the first threshold time or more (Yes in S545), the vehicle 2000 may be determined to experience the sudden unintended acceleration event by the sudden unintended acceleration determination unit 50. The control signal may be generated by the control unit 60 to end the first mode and perform the second mode if the vehicle 2000 is determined to experience the sudden unintended acceleration event by the sudden unintended acceleration determination unit 50 (S60).

The checking of the information on the driver foot position state described above (S540) and the comparing of the real-time acceleration duration of the vehicle 2000 with the predetermined first threshold time (S545) may be performed sequentially.

However, the present disclosure is not necessarily limited thereto, and the steps S540 and S545 may be performed simultaneously, or may be performed in an order of the comparing of the real-time acceleration duration of the vehicle 2000 with the predetermined first threshold time (S545) and then the checking of the information on the driver foot position state (S540).

Meanwhile, the first speed received through the communication unit 40 may be compared with a predetermined third speed by the sudden unintended acceleration determination unit 50 (S550) if the driver foot position state in the vehicle 2000 is the second state (No in S540) in the checking of the information on the driver foot position state (S540) or if the real-time acceleration duration of the vehicle 2000 is less than the first threshold time in the comparing of the real-time acceleration duration of the vehicle 2000 with the predetermined first threshold time (S545).

The third speed is a value predetermined and stored in the second storage unit 303, and may indicate a speed that serves as a reference for determining that the vehicle 2000 experiences the sudden unintended acceleration event if the vehicle 2000 is driven at the third speed or more for a certain period of time.

In some embodiments, the third speed may be a value of 110 km/h or more, which is the maximum speed standard of a domestic expressway.

Whether the vehicle 2000 experiences the sudden unintended acceleration may be determined by the sudden unintended acceleration determination unit 50 based on duration of the first speed (S555) if the first speed is the third speed or more (Yes in S550).

That is, the vehicle 2000 may be determined to experience the sudden unintended acceleration event by the sudden unintended acceleration determination unit 50 if the first speed is the third speed or more and continues for a second threshold time or more (Yes in S555). The control signal may be generated by the control unit 60 to end the first mode and perform the second mode if the vehicle 2000 is determined to experience the sudden unintended acceleration event by the sudden unintended acceleration determination unit 50 (S60).

The second threshold time is a value predetermined and stored in the second storage unit 303, and may be a threshold time that serves as a reference for determining whether the vehicle 2000 experiences the sudden unintended acceleration event if the vehicle 2000 is driven at a reference speed (or the third speed) or more for the certain period of time.

In some embodiments, the second threshold time may be set from 0.5 to 10 minutes.

The comparing of the first speed with the predetermined third speed described above (S550) and the determining of whether the first speed is the third speed or more and continues for the second threshold time or more (S555) may be performed sequentially in the above-described order.

In some embodiments, the method may further include generating, by the control unit 60, an overspeed warning signal for the driver (not shown) after the comparing of the first speed with the predetermined third speed (S550).

That is, the overspeed warning signal may be generated by the control unit 60 if the first speed is determined to be the third speed or more by the sudden unintended acceleration determination unit 50 (Yes in S550). The overspeed warning signal may be generated by the control unit 60, the overspeed warning signal being transmitted to the driver through at least one of a display part (not shown) of the vehicle 2000, the user interface 2008, or the voice signal.

If the vehicle 2000 is continuously driven at the third speed or more for the second threshold time or more (Yes in S555), the vehicle 2000 may be determined to experience the sudden unintended acceleration event by the sudden unintended acceleration determination unit 50. The control signal may be generated by the control unit 60 to end the first mode and perform the second mode if the vehicle 2000 is determined to experience the sudden unintended acceleration event by the sudden unintended acceleration determination unit 50 (S60).

Meanwhile, whether the sudden unintended acceleration event occurs may be determined by the sudden unintended acceleration determination unit 50 based on the voice signal input through the input unit 70 (S560 and S565) if the first speed is less than the third speed (No in S550) or if the first speed is the third speed or more and continues for less than the second threshold time (No in S555).

The voice signal may be generated based on the speech of the driver and all the passengers riding in the vehicle 2000, and the speech of the driver and all the passengers may be converted, by the input unit 70, into the data and transmitted to the sudden unintended acceleration determination unit 50, the control unit 60, and the like.

First, whether a predetermined instruction is included in the voice signal may be determined by the sudden unintended acceleration determination unit 50 (S560). The instruction may be stored in the second storage unit 303 as predetermined words that may be used to infer the sudden unintended acceleration event, including “the sudden unintended acceleration”.

In the step S560, if at least one of the words set as the instruction in the voice signal is determined to be included (Yes in S560), whether the vehicle experiences the sudden unintended acceleration may be determined by the sudden unintended acceleration determination unit 50 by measuring a decibel value of the voice signal and comparing the measured decibel value with a predetermined decibel value (S565).

The predetermined decibel value is a value predetermined and stored in the second storage unit 303, and may be a reference value for determining that the sudden unintended acceleration event occurs when the decibel value of the voice signal is more than the predetermined decibel value.

In the step S565, if the decibel value of the voice signal is more than the predetermined decibel value (Yes in S565), the vehicle 2000 may be determined to currently experience the sudden unintended acceleration event by the sudden unintended acceleration determination unit 50. The control signal may be generated by the control unit 60 to end the first mode and perform the second mode if the vehicle 2000 is determined to experience the sudden unintended acceleration event by the sudden unintended acceleration determination unit 50 (S60).

That is, the voice signal may be analyzed by the sudden unintended acceleration determination unit 50 to determine whether the instruction is included (S560) and whether the vehicle 2000 experiences the sudden unintended acceleration event using the decibel value of the voice signal as a reference (S565).

Meanwhile, whether the sudden unintended acceleration event occurs may be determined by the sudden unintended acceleration determination unit 50 based on whether the manual manipulation signal is input from the input unit 70 (S570) if the voice signal does not include the predetermined instruction (No in S560) or the decibel value of the voice signal is less than the predetermined decibel value (No in S565).

The emergency button (not shown) may be included in the pedal black box 1. The emergency button may be integrated with the pedal black box 1 or may be formed independently on the dashboard, room mirror, or the like of the vehicle 2000.

The manual manipulation signal may be a signal input by manual manipulation by the driver or the passenger. When the emergency button is pushed by the driver or the passenger, the manipulation of the emergency button may be detected by the control unit 60 and the manual manipulation signal may be transmitted to the sudden unintended acceleration determination unit 50.

That is, the vehicle 2000 may be determined to experience the sudden unintended acceleration event by the sudden unintended acceleration determination unit 50 if the manual manipulation signal is received from the control unit 60 (Yes in S570). The first mode may be ended and the second mode may be performed, by the control unit 60, if the vehicle 2000 is determined to experience the sudden unintended acceleration event by the sudden unintended acceleration determination unit 50 (S60).

In this embodiment, the steps S520, S530, S540, S550, S560, and S570 for determining whether the sudden unintended acceleration event occurs are shown to be performed sequentially. However, the present disclosure is not necessarily limited thereto, and the steps S520, S530, S540, S550, S560, and S570 may be performed simultaneously.

Hereinafter, the ending of the first mode and performing the second mode (S60) is described in more detail with reference to FIGS. 1 to 4 and 6.

The control signal may be generated by the control unit 60 to end the first mode (S610) if the vehicle 2000 is determined to experience the sudden unintended acceleration event in the determining of whether the sudden unintended acceleration event occurs (S50).

When the first mode ends (S610), a notification may be generated by the control unit 60 to inform the driver of the second mode operation. The second mode operation notification may be transmitted to the driver through a guidance voice or the display part (not shown).

When the first mode ends, the control signal may be generated by the control unit 60 to perform the second mode (S630). As the step S630 is performed, the video of the pedal part that is filmed by the camera unit 20 may be stored in both the first storage unit 301 and the external storage device 2.

The generating of the second mode operation notification (S620) and the performing of the second mode (S630) may be performed simultaneously.

When the second mode is performed (S630), determining whether the sudden unintended acceleration event continues at a predetermined interval may be performed by the sudden unintended acceleration determination unit 50 (S640).

The step S640 may be performed as a process substantially the same as the determining of whether the sudden unintended acceleration event occurs (S50) described with reference to FIG. 5, and the description thus omits a detailed description thereof.

In the step S640, if the sudden unintended acceleration event of the vehicle 2000 is determined to continue (Yes in S640), the control signal may be continuously generated by the control unit 60 to control the filmed data to be stored in the second mode (S630).

Meanwhile, in the step S640, if the sudden unintended acceleration event of the vehicle 2000 is determined to end (No in S640), the control signal may be generated by the control unit 60 to perform the first mode while the control signal is simultaneously generated to end the second mode (S650).

That is, the method of recording sudden unintended acceleration of the vehicle 2000 using the pedal black box 1 according to the embodiments of the present disclosure may inhibit the loss or damage of the video data by performing a storage mode of the video data in the second mode for storing the video data in both the first storage unit 301 and the external storage device 2 if the suspected sudden unintended acceleration event occurs.

In addition, the method for recording sudden unintended acceleration of a vehicle using a pedal black box according to the embodiments of the present disclosure may inhibit the loss of the video data of the pedal black box, thus allowing the data to be used as evidence in legal liability or civil/criminal lawsuits when the suspected sudden unintended acceleration accident occurs.

Although the various embodiments of the present disclosure have been specifically described above, those skilled in the art to which the present disclosure pertains may appreciate that the embodiments described above may be changed in various ways without departing from the scope of the present disclosure. Accordingly, the scope of the present disclosure is not construed as being limited to the described embodiments, and defined by the appended claims as well as equivalents thereto.

### DESCRIPTION OF REFERENCE NUMERALS IN THE DRAWINGS

1: pedal black box
10: power supply unit
20: camera unit
30: storage unit
40: communication unit
50: sudden unintended acceleration determination unit
60: control unit
70: input unit
80: converter
2: external storage device

1. A method for recording sudden unintended acceleration of a vehicle using a pedal black box, in which the box includes a camera unit, a communication unit, a control unit, a storage unit, an input unit, and a sudden unintended acceleration determination unit, the method comprising:
acquiring, from the camera unit, filmed video data of a surrounding area of a pedal part of the vehicle;
performing, by the control unit, a first mode for storing the video data in at least one of the storage unit or an external storage device disposed independently of the pedal black box;
determining, by the sudden unintended acceleration determination unit, whether the vehicle experiences a sudden unintended acceleration event; and
ending, by the control unit, the first mode and performing a second mode for storing the video data in both the storage unit and the external storage device if the vehicle is determined to experience the sudden unintended acceleration event in the determining of whether the vehicle experiences the sudden unintended acceleration event.

2. The method of claim 1, wherein the determining of whether the vehicle experiences the sudden unintended acceleration event includes receiving, through the communication unit, information on the vehicle from the vehicle.

3. The method of claim 2, wherein the information on the vehicle includes a first speed indicating a real-time driving speed of the vehicle, a second speed indicating a real-time global positioning system (GPS) speed of the vehicle, a first acceleration indicating real-time acceleration of the vehicle, a driver foot position state, and real-time acceleration duration of the vehicle.

4. The method of claim 3, wherein the determining of whether the vehicle experiences the sudden unintended acceleration event further includes determining whether the vehicle experiences the sudden unintended acceleration event by comparing the first acceleration received through the communication unit with a predetermined second acceleration.

5. The method of claim 4, wherein in the determining of whether the vehicle experiences the sudden unintended acceleration event,
the vehicle is determined to experience the sudden unintended acceleration event by the sudden unintended acceleration determination unit if the first acceleration is the second acceleration or more.

6. The method of claim 3, wherein the determining of whether the vehicle experiences the sudden unintended acceleration event further includes determining whether the vehicle experiences the sudden unintended acceleration event by comparing a predetermined value with a difference value between the first speed and the second speed, received through the communication unit.

7. The method of claim 6, wherein in the determining of whether the vehicle experiences the sudden unintended acceleration event,
the vehicle is determined to experience the sudden unintended acceleration event by the sudden unintended acceleration determination unit if the difference value between the first speed and the second speed is the predetermined value or more.

8. The method of claim 3, wherein the determining of whether the vehicle experiences the sudden unintended acceleration event further includes
checking information on the driver foot position state in the vehicle that is received through the communication unit, and
determining whether the vehicle experiences the sudden unintended acceleration event by comparing a predetermined first threshold time with the real-time acceleration duration of the vehicle that is received through the communication unit.

9. The method of claim 8, wherein the driver foot position state in the vehicle includes a first state in which a driver foot is spaced apart from a brake by a predetermined distance, and a second state in which the driver foot presses the brake.

10. The method of claim 9, wherein in the determining of whether the vehicle experiences the sudden unintended acceleration event,
the vehicle is determined to experience the sudden unintended acceleration event by the sudden unintended acceleration determination unit if the driver foot position state in the vehicle is the first state and the real-time acceleration duration of the vehicle is the first threshold time or more.

11. The method of claim 8, wherein the checking of the information on the driver foot position state in the vehicle and the determining of whether the vehicle experiences the sudden unintended acceleration event are performed sequentially.

12. The method of claim 3, wherein the determining of whether the vehicle experiences the sudden unintended acceleration event further includes comparing the first speed received through the communication unit with a predetermined third speed.

13. The method of claim 12, wherein in the comparing of the first speed with the predetermined third speed,
whether the vehicle experiences the sudden unintended acceleration is determined by the sudden unintended acceleration determination unit based on duration of the first speed if the first speed is the third speed or more.

14. The method of claim 13, wherein the vehicle is determined to experience the sudden unintended acceleration event by the sudden unintended acceleration determination unit if the first speed is the third speed or more and the duration of the first speed is a predetermined second threshold time or more.

15. The method of claim 2, wherein the determining of whether the vehicle experiences the sudden unintended acceleration event further includes determining whether a predetermined instruction is included in a voice signal generated based on speech of a driver and a passenger that is input through the input unit.

16. The method of claim 15, wherein in the determining of whether the predetermined instruction is included in the voice signal, if the instruction is included in the voice signal, whether the vehicle experiences the sudden unintended acceleration is determined by the sudden unintended acceleration determination unit by comparing a decibel value of the voice signal with a predetermined decibel value.

17. The method of claim 16, wherein the vehicle is determined to experience the sudden unintended acceleration event by the sudden unintended acceleration determination unit if the instruction is included in the voice signal and the decibel value of the voice signal is the predetermined decibel value or more.

18. A pedal black box for recording sudden unintended acceleration of a vehicle, the box comprising:
a camera unit configured to generate video data by filming a surrounding area of a pedal part of the vehicle;
a storage unit including a first storage unit configured to store the video data generated by the camera unit;
a communication unit configured to communicate with an external device and receiving information on the vehicle from the vehicle;
a sudden unintended acceleration determination unit configured to determine whether the vehicle experiences a sudden unintended acceleration event based on the information on the vehicle that is received through the communication unit; and
a control unit configured to select and perform at least one of a first mode and a second mode based on a signal from the sudden unintended acceleration determination unit,
wherein in the second mode, the video data is stored in both the storage unit and an external storage device disposed independently of the pedal black box through the communication unit.

19. (canceled)

20. A computer-readable recording-medium including a program code for executing the method for recording sudden unintended acceleration of a vehicle using a pedal black box as claimed in claim 1.
